(19) United States
(12) Patent Application Publication
(10) Pub. No.: US 2025/0084543 A1
(43) Pub. Date: Mar. 13, 2025

(54) Electrode Microstructure and Method for Fabricating the Same

(71) Applicant: SENSE-TECH INNOVATION COMPANY, New Taipei City (TW)

(72) Inventors: Meng-Tsung WU, New Taipei City (TW); Kuo-Yuan LING, New Taipei City (TW); Chien-Tai FANG, New Taipei City (TW)

(21) Appl. No.: 18/817,203

(22) Filed: Aug. 27, 2024

(30) Foreign Application Priority Data
Sep. 8, 2023 (TW) 112134342
Apr. 12, 2024 (TW) 113113678

(51) Int. Cl. C25B 11/02; H01B 13/00

(52) U.S. Cl. CPC C25B 11/02; H01B 13/0036

(57) ABSTRACT

An electrode microstructure and a method for fabricating the same are provided. The electrode microstructure includes a plastic part and a surface structural layer disposed on a surface of the plastic part. The surface structural layer includes a one-dimensional metal nanocrystal structure, the surface structural layer includes a plurality of microstructures, each of the plurality of microstructures is spaced apart from each other and distributed on the surface of the plastic part, and each of the plurality of microstructures includes at least one conical portion for tip discharge. The conical portion of the microstructures for tip discharge enhance the process efficiency of the subsequent electroplating electrode microstructure, and the conical portion of the microstructures can provide larger surface area to react with the electroplating material.

### CROSS REFERENCE TO RELATED APPLICATION

This application claims the priority benefit of Taiwan Patent Application No. 112134342, filed on Sep. 8, 2023 and Taiwan Patent Application No. 113113678, filed on Apr. 12, 2024, the full disclosures of which are incorporated herein by reference.

### BACKGROUND

### Technical Field

The present application is related to the technical field of electrode structure, particularly to an electrode microstructure and a method for fabricating an electrode microstructure.

### Related Art

In the existing technology, nanotechnology encompasses a broad range of fields, and nanomaterials constitute just a part of it. However, the nanomaterials form the foundation for the development of nanotechnology. The outstanding properties of nanomaterials can be applied in various fields. Nanomaterials refer to materials in which at least one dimension is at the nanoscale (0.1 to 100 nm). They include zero-dimensional, one-dimensional, and two-dimensional nanomaterials. Any material with at least one dimension in the nanoscale range is considered a nanomaterial. When the dimensions of materials are nanoscale, a series of phenomena and effects emerge due to their unique physical structure, which may lead to a series of corresponding applications.

### SUMMARY

The embodiments of the present application provide an electrode microstructure and a method for fabricating the same, and the surface microstructure of the electrode structure is fabricated through the nanomaterial to improve the electroplating effect.

In order to address the technical issues mentioned above, the present application is implemented as follows:

In the first aspect, a method for fabricating an electrode microstructure is provided. The method includes steps of: providing a plastic part with flexibility; and sputtering a surface structural layer onto a surface of the plastic part to form the electrode microstructure. The surface structural layer includes a one-dimensional metal nanocrystal structure, the surface structural layer includes a plurality of microstructures, each of the plurality of microstructures is spaced apart from each other and distributed on the surface of the plastic part, and each of the plurality of microstructures includes at least one conical portion for tip discharge.

In one embodiment, after the step of forming the electrode microstructure, the method further includes a step of rolling the electrode microstructure to form a coiled material, wherein the surface structural layer is exposed outside of the coiled material.

In one embodiment, the surface structural layer includes a material of copper tungsten alloy, silver tungsten alloy, platinum, nickel fiber, nickel-copper, ruthenium dioxide, nickel-ruthenium, copper-ruthenium or tin antimony oxide.

In one embodiment, each of the plurality of microstructures includes a nanoscale height and a nanoscale width between 1 nm and 50 nm.

In the second aspect, an electrode microstructure is provided. The electrode microstructure includes a plastic part and a surface structural layer. The surface structural layer includes a one-dimensional metal nanocrystal structure, the surface structural layer includes a plurality of microstructures, each of the plurality of microstructures is spaced apart from each other and distributed on the surface of the plastic part, and each of the plurality of microstructures includes at least one conical portion for tip discharge.

In one embodiment, the plurality of microstructures includes a shape including tubular, columnar, filamentous, strip-shaped, needle-like, helical and/or annular.

In one embodiment, each of the microstructures includes a nanoscale height and a nanoscale width between 1 nm and 50 nm.

The present application provides a method for fabricating an electrode microstructure and the electrode microstructure itself. The method involves sputtering a surface structural layer onto the surface of the plastic part to form the electrode microstructure, the surface structural layer includes a one-dimensional metal nanocrystal structure, the surface structural layer includes a plurality of microstructures, each of the plurality of microstructures is spaced apart from each other and distributed on the surface of the plastic part, and each of the plurality of microstructures includes at least one conical portion, allowing tip discharge to enhance the process efficiency of the subsequent electroplating electrode microstructure. The conical bodies of the microstructures can provide a larger surface area to react with the electroplating material. Additionally, the surface structural layer has an incomplete rough structure surface which also strengthens the bond with the electroplating materials.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The accompanying drawings herein are provided to have a further understanding on the present application and constitutes a part of the present application. The schematic embodiments and the description of the present application is used to explain the present application instead of constituting inappropriate limitation. In the drawings:

FIG. 1 is a flowchart illustrating the steps of the method for fabricating the electrode microstructure according to the present application;

FIG. 2 is a schematic diagram of the electrode microstructure according to the present application; and

FIG. 3 is another schematic diagram of the electrode microstructure according to the present application.

### DETAILED DESCRIPTION OF THE EMBODIMENTS

The multiple embodiments of the present application are disclosed by the drawings as follows, and for precise explanation, the implementing details of the present application will be described together with the multiple embodiments of the present application in the following paragraphs. However, it should be understood that the implementing details of the present application should not be construed as the restrictions of the present application. In other words, in some of the embodiments of the present application, the implement details of the present application are not essential. Besides, for simplifying the drawings, some well-known structures and modules are schematically shown to simplify the drawings. In the following embodiments, the same reference numerals in different drawings represent the same or similar modules.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that comprises a series of elements not only include these elements, but also comprises other elements not specified expressly, or may include inherent elements of the process, method, object, or device. If no more limitations are made, an element limited by “include a/an . . . ” does not exclude other same elements existing in the process, the method, the article, or the device which comprises the element.

In the following embodiment, the same reference numerals are used to refer to the same or similar elements throughout the invention.

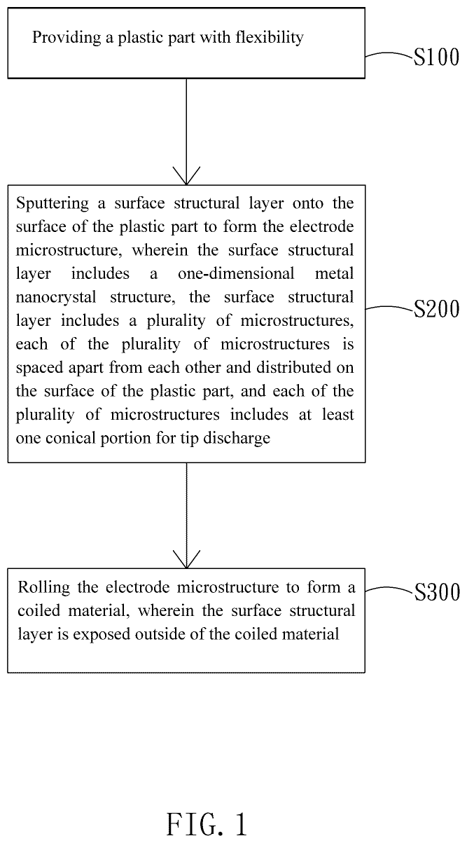

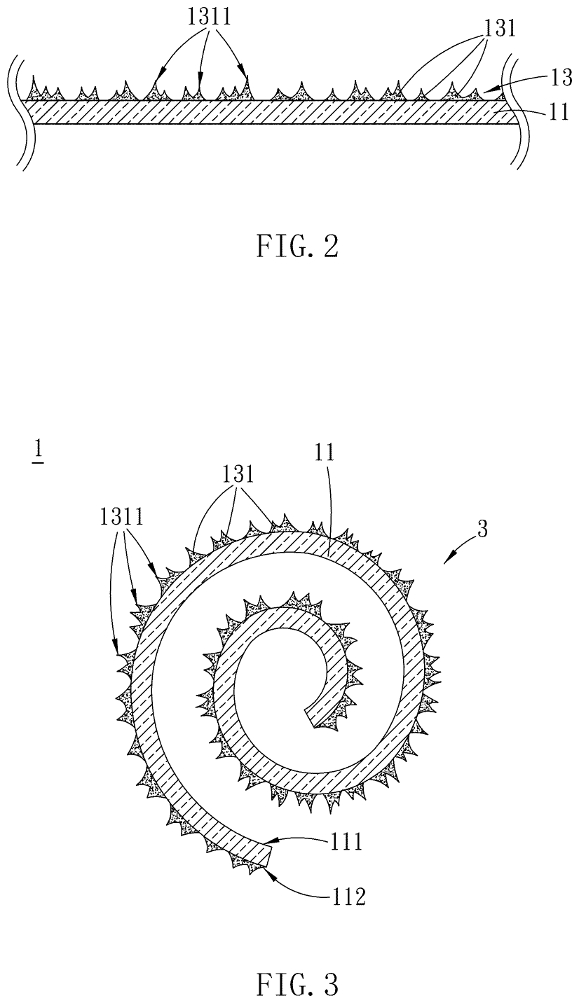

Please refer to FIG. 1 and FIG. 2, where FIG. 1 is a flowchart illustrating the steps of the method for fabricating the electrode microstructure according to the present application, and FIG. 2 is a schematic diagram of the electrode microstructure. As shown in the figures, this application provides a method for fabricating electrode microstructure, and the steps S includes:
Step S100: providing a plastic part 11. In this embodiment, the plastic part 11 is Polyethylene Terephthalate (PET). The plastic part 11 is used as a foundation structure, and can be rolled into a coiled structure which is advantageous for use in the subsequent process.
Step S200: sputtering a surface structural layer 13 onto the surface of the plastic part 11 to form an electrode microstructure 1, wherein the surface structural layer 13 includes a one-dimensional metal nanocrystal structure, the surface structural layer 13 includes a plurality of microstructures 131, each of the plurality of microstructures 131 is spaced apart from each other and distributed on the surface of the plastic part 11, and each of the plurality of microstructures 131 includes at least one conical portion 1311 for tip discharge.

In this embodiment, the plastic part 11 is processed by sputtering. Sputtering is a physical vapor deposition technique that involves the physical process of atoms in the target material being dislodged by the impact of high-energy ions and entering the gas phase. In sputtering, a stable vacuum environment is maintained, and high-pressure negative electrical potential is applied to generate a plasma from inert gas. The target material is positioned at the cathode, while the material to be coated is placed at the anode. Positively charged ions from the ionized inert gas bombard the surface of the target material, causing atoms from the target material's surface to be dislodged and deposited onto the material to be coated, forming a surface structure. In this embodiment, the target material includes copper tungsten alloy, silver tungsten alloy, platinum, nickel fiber, nickel-copper, ruthenium dioxide, nickel-ruthenium, copper-ruthenium or tin antimony oxide. The material to be coated is a flexible plastic part 11. After the atoms of the target material, including copper tungsten alloy, silver tungsten alloy, platinum, nickel fiber, nickel-copper, ruthenium dioxide, nickel-ruthenium, copper-ruthenium or tin antimony oxide, are dislodged by the impact of positive ions from the inert gas, they deposit on the surface of the plastic part 11 to form a surface structural layer 13, wherein the surface structural layer 13 includes a one-dimensional nanocrystal material. The structure of one-dimensional nanocrystal refers that the two dimensions, width and height, of the three dimensions, length, width and height, are both nanoscales, and the sizes of both width and height are between 1 nm and 50 nm. Additionally, besides the conical portion 1311, the shape of one-dimensional nanocrystal further includes tubular, columnar, filamentous, strip-shaped, needle-like, helical and/or annular shape.

As mentioned above, during the process of gradually forming the target material on the surface structural layer 13, the sputtered target material on the surface of the plastic part 11 cannot form complete surface, i.e. the condition of the surface structural layer 13 sputtered on the surface of the plastic part 11 cannot meet the requirement of forming complete surface structure of two-dimensional metal nanocrystal. In other words, the condition of the surface structural layer 13 sputtered on the surface of the plastic part 11 has the structure characteristic of incomplete surface composed of one-dimensional metal nanocrystal structure.

Furthermore, the surface structural layer 13 includes a plurality of microstructures 131. Each of the plurality of microstructures 131 is spaced apart from each other and distributed on the surface of the plastic part 11. The plurality of microstructures 131 present block-like and island-like separation structures, and the lateral side of each microstructures 131 does not connect to each other.

Furthermore, when the plurality of microstructures 131 of the surface structural layer 13 are distributed on the plastic part 11, each microstructure 131 includes at least one conical portion 1311. The conical portion 1311 of the microstructure 131 can provide tip discharge. In other words, the sharper the conductor tip, the more obvious the tip effect. Because the surface charge density is higher in places with large curvature of the object surface (such as sharp points and the tips of small objects), the stronger the electric field intensity is, thus enhancing the effect of electron discharge. In other words, because each microstructure 131 is spaced apart from each other, each microstructure 131 can be deemed a single dischargeable structure. The conical bodies 1311 of the microstructures 131 of the surface structural layer 13 can produce a tip discharge effect, which is beneficial to enhance the effect of electron discharge and improve process efficiency. So in this embodiment, the discharge effect of the conical portions 1311 of the microstructures 131 of the surface structural layer 13 is beneficial to the use of electrolyzing water or material precipitation, which can be used according to the uses' requirement.

Furthermore, the surface structural layer whose the incomplete rough surface includes one-dimensional metal nanocrystal structure, i.e., the conical portion 1311 of each microstructures 131 makes the surface of the surface structural layer 13 present rugged three-dimensional structures. Compared to the general complete surface, the surface of the surface structural layer 13 composed of one-dimensional metal nanocrystal structure has a larger surface area, and is beneficial to provide larger surface area to react with the electroplating material to process the electroplating manufacture. The rough structure surface of the surface structural layer 13 can also improve the strength of bond with the electroplating material.

Please refer to FIG. 1 and FIG. 3, FIG. 3 is another schematic diagram of the electrode microstructure according to the present application. As shown in the figure, in this embodiment, step S300: because the base is a flexible plastic part 11 in this embodiment, after the step of forming the electrode element, the microstructure 1 can further be rolled to form a coiled material 3, and the surface of the electrode microstructure 1 with the surface structural layer 13 are rolled outside to form an outer surface 112 of the coiled material 3. In addition, according to the uses' requirement, another surface structural layer (not shown) can be made on the other surface opposite to the outer surface 112, i.e. the inner surface 111 of the plastic part 11.

As mentioned above, the present application provides an electrode microstructure and the method for fabricating it by forming a surface structural layer including a one-dimensional metal nanocrystal structure on a conductive element in which the surface structural layer is an incomplete rough surface to create a larger surface area. The surface structural layer includes a plurality of microstructures distributed on the conductive layer, and each of the microstructures includes at least one conical portion. The conical portion of the microstructure can provide tip discharge, being beneficial for the subsequent process efficiency of electroplating conductive element, and also provides a larger surface area to react with the electroplated material, and meanwhile the rough surface of the surface structural layer can enhance the bonding strength with the electroplating material.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiment, it does not intend to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. A method for fabricating an electrode microstructure comprising steps of:
providing a plastic part with flexibility; and
sputtering a surface structural layer onto a surface of the plastic part to form the electrode microstructure,
wherein the surface structural layer comprises a one-dimensional metal nanocrystal structure, the surface structural layer comprises a plurality of microstructures, each of the plurality of microstructures is spaced apart from each other and distributed on the surface of the plastic part, and each of the plurality of microstructures includes at least one conical portion for tip discharge.

2. The method for fabricating an electrode microstructure as claimed in claim 1, after the step of forming the electrode microstructure, further comprising a step of rolling the electrode microstructure to form a coiled material, wherein the surface structural layer is exposed outside of the coiled material.

3. The method for fabricating an electrode microstructure as claimed in claim 1, wherein the surface structural layer comprises a material of copper tungsten alloy, silver tungsten alloy, platinum, nickel fiber, nickel-copper, ruthenium dioxide, nickel-ruthenium, copper-ruthenium or tin antimony oxide.

4. The method for fabricating an electrode microstructure as claimed in claim 1, wherein each of the plurality of microstructures comprises a nanoscale height and a nanoscale width between 1 nm and 50 nm.

5. An electrode microstructure comprising:
a plastic part; and
a surface structural layer disposed on a surface of the plastic part, wherein the surface structural layer comprises a one-dimensional metal nanocrystal structure, the surface structural layer comprises a plurality of microstructures, each of the plurality of microstructures is spaced apart from each other and distributed on the surface of the plastic part, and each of the plurality of microstructures comprises at least one conical portion for tip discharge.

6. The electrode microstructure as claimed in claim 5, wherein the plurality of microstructures further comprises a shape comprising tubular, columnar, filamentous, strip-shaped, needle-like, helical and/or annular.

7. The electrode microstructure as claimed in claim 5, wherein each of the plurality of microstructures comprises a nanoscale height and a nanoscale width between 1 nm and 50 nm.
